(19) United States
(12) Patent Application Publication
(10) Pub. No.: US 2019/0182234 A1
(43) Pub. Date: Jun. 13, 2019

(54) STORING, MANAGING AND ACCESSING INFORMATION IN A REPOSITORY WITHIN A SECURITY CONTEXT

(71) Applicant: HANSELWARE, INC., Seattle, WA (US)

(72) Inventors: Greg BOUWENS, Seattle, WA (US); Justus GICHABA, Woodbridge, VA (US)

(21) Appl. No.: 16/326,130

(22) PCT Filed: Aug. 15, 2017
(86) PCT No.: PCT/US2017/047033

§ 371 Date: Feb. 15, 2019

Related U.S. Application Data
(60) Provisional application No. 62/375,434, filed on Aug. 16, 2016.

(51) Int. Cl. H04L 29/06; H04L 29/08; G06F 16/93; G06F 3/12; H04N 1/32

(52) U.S. Cl. CPC H04L 63/0815; H04L 67/02; G06F 16/93; H04N 1/32358; G06F 3/1276; G06F 3/1285; G06F 3/1204

(57) ABSTRACT

Systems, devices and methods are shown for managing documents in a security context that provide an appliance service (310) that establishes (374, 376, 380, 382) a security context with a content management service (330) for a user of the client device, present the appliance service (388) on the display as an option in an operating system resource management user interface, receive a user document storage command (370) from the user input device indicating that a document is to be stored, and responsive to receiving the user document storage command, sending a document storage command (394) with the document from the appliance service to the content management service for storage in the security context for the user.

### CROSS REFERENCE TO RELATED APPLICATIONS

This application claims the benefit of U.S. Provisional Patent Appl. No. 62/375,434 for “System and Method for Storing, Managing and Accessing Information in a Repository within a Security Context” filed Aug. 16, 2016, herein incorporated by reference in its entirety for all purposes.

### BACKGROUND

Client devices such as desktop computers, tablets, and smartphones are widely used by knowledge workers to create and modify information. Client devices typically have network connections available so they can receive and transmit information to and from repositories, which are generally specialized instances of databases that have been optimized for storage and retrieval of managed information, such as documents or images.

Access control technology, such as Single-sign-on (SSO), provides for a user to log in to multiple related, but independent, systems using a single identifier and password to obtain access to the multiple systems. SSO, for example, is a client device security configuration that authenticates a user's credentials once in order to reduce, or eliminate, repeatedly prompting a user to authenticate as she uses different secured resources and repositories while she uses her client device. Client devices typically have several, and often dozens of software applications available.

### SUMMARY

The present system and method are generally directed to storing managed information in a repository and providing controlled access of users to the managed information. Some embodiments of the present system and method involve a standardized way to connect client systems that access and modify managed information to repositories where the managed information is maintained. Some embodiments of the present system and method involve detecting a security context under which a user of a client system is operating. Some embodiments of the present system and method involve storing information from a client system to a repository.

According to one aspect of the present approach, an example of a system for integrating client devices with repositories in a security context includes a client user-mode driver disposed in a client device; and an appliance device; wherein the client user-mode driver is configured to communicate with the appliance device to generate requests to the appliance responsive to a user of the client device. The appliance device or service is configured to communicate with authentication providers to authenticate users of a client device and communicate with the client user-mode driver and repositories to manage documents and information, where, once a user is authenticated for a security context, the appliance identifies the available repositories for the security context and metadata needed for managing the documents and information for presentation to the authenticated user via the client user-mode driver, and prompts the user to identify a repository for the documents and information along with the required metadata, and, responsive to a print request from the client user-mode driver, commit a document to the selected repository with the defined metadata.

In a further example, the client user-mode driver is implemented as a print driver that is integrated into the function of the client device. In another example, the appliance further includes a web browser interface configured to interface with a user of the client device to display available repositories for the user's security context and receive a user selection of one or more of the available repositories. In still another example, the web browser interface is further configured to prompt the user for metadata for the available repositories and receive a user's definition of the metadata.

### BRIEF DESCRIPTION OF THE DRAWINGS

Various embodiments in accordance with the present disclosure will be described with reference to the drawings, in which:

FIG. 1 is a schematic diagram depicting an example of a network architecture suitable for utilization of certain embodiments of the present invention;

FIG. 2 is a schematic diagram depicting one example of an architecture demonstrating certain aspects of the present system and method:

FIG. 3 is sequence diagram illustrating an example of an exchange of messages and information in accordance with certain aspects of the present system and method;

FIG. 4 is a sequence diagram illustrating an example of an exchange of messages and information in accordance with certain aspects of the present system and method pertaining to federation services with single sign on (SSO) context;

FIG. 5 is an architecture diagram illustrating an example of a client device with a client user-mode print driver configured as described herein with a communication connection to an appliance service;

FIG. 6 is a sequence diagram illustrating one example of messaging and processing in the architecture of FIG. 5;

FIG. 7 is a sequence diagram illustrating examples of print job for documents in accordance with the present approach in both a SSO context and a non-SSO context;

FIG. 8 is a sequence diagram illustrating an example of a scenario for querying or browsing for documents in accordance with certain aspects of the present approach:

FIG. 9 is a control flow diagram illustrating one example of a process for storing a document in accordance with certain aspects of the present approach, where the appliance service appears to the user as a printer device:

FIG. 10 is a control flow diagram illustrating another example of a process for storing a document in accordance with certain aspects of the present approach, where the appliance service authenticates the user, identifies repositories available to the user within the established security context and presents the identified repositories to the user for selection;

FIG. 11 is a control flow diagram illustrating still another example of a process for storing a document in accordance with certain aspects of the present approach, where the user is authenticated by an authentication provider, a list of repositories available to the user within the established security context is determined and provided, and a save or print request is received with a document, a destination repository, and meta-data pertaining to the document:

FIG. 12A is a schematic diagram illustrating an example of a document application on a client device utilized to create a document;

FIG. 12B is a schematic diagram illustrating an example of a user interface presenting an appliance service to a user in the example of FIG. 12A in accordance with certain aspects of the present approach;

FIG. 12C is a schematic diagram illustrating an example of a user interface for the appliance service to prompt the user for user credentials in the example of FIGS. 12A-B in accordance with certain aspects of the present approach;

FIG. 12D is a schematic diagram illustrating an example of a user interface for the appliance service to present object stores available to the user in the security context established with the user credentials in the example of FIGS. 12A-C in accordance with certain aspects of the present approach;

FIG. 12E is a schematic diagram illustrating an example of a user interface for the appliance service to present a list of available object stores available to the user in the security context established with the user credentials in the example of FIGS. 12A-D in accordance with certain aspects of the present approach;

FIG. 12F is a schematic diagram illustrating an example of a user interface for the appliance service with an object store and document class selected and meta-data pertaining to the document sample in the example of FIGS. 12A-E in accordance with certain aspects of the present approach:

FIG. 13 is a schematic diagram illustrating an example of a resource management interface of an operating system illustrating a directory structure showing the storage of the sample document in the selected repository along with the meta-data pertaining to the document sample in the example of FIGS. 12A-F in accordance with certain aspects of the present approach; and

FIG. 14 depicts aspects of elements that may be present in a computer device and/or system configured to implement a method, system and/or process in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Client devices may have a variety of hardware and operating system platforms, such as Windows, Macintosh. Linux, Android and iPhone, as well as different versions of these platforms. Similarly, users of client devices utilize a large variety of productivity applications, such as Excel, Word, PowerPoint, Visio, business apps like Salesforce, PeopleSoft, Microsoft Dynamics CRM, SAS, and many others. In addition, organizations may utilize a variety of repositories (and versions thereof) to manage their documents and information including, for example, SharePoint, FileNet, IBM Content Manager, Dropbox, Box, Alfresco. The result is a large number of permutations of platforms, applications and repositories, which may require integration solutions that are specifically adapted for each permutation.

The present approach is generally directed toward systems and methods involving installation of an appliance that is configured to direct documents to one or more selected repositories and installation of a driver on a client device, such as a print driver, that is configured to direct documents to the appliance. Installation and configuration of the driver is relatively straightforward for users or administrators of client devices. Once installed, a user can manage a document or information from an application program by simply invoking the driver without leaving the application program. For example, the user may initiate a print operation for a document, such as by selecting control p in the application program, selecting the installed driver, and printing the document to the driver. The driver then forwards the document to the appliance and the appliance directs the document to the configured repositories. The end user is shielded from much of the complexity of multiple platforms, applications and repositories and utilizes a simple, familiar action, e.g. a print operation, to quickly and easily send documents and information to a repository from their applications.

An example of one implementation of repository integration in accordance with certain aspects of the present approach, which is only an example and does not limit the scope of the present approach, involves a printer driver configured on a client device to operate as an appliance to store documents in a secure repository, as described in further detail below. In this example, the appliance is previously configured to direct documents received through the print driver to one or more predetermined repositories. In this example, a document created by a user of a client application is able to send the document to predetermined repositories by using Control-P to initiate a print operation and selecting the appliance print driver from the drop-down menu of the print window. Variations on this example are possible that do not depart from the teachings and scope of the present approach described herein.

Certain examples of the present system and method are directed toward providing integration between client software applications and central repositories. More generally, these examples may enable a simpler and more generalized way to connect client systems to repositories, detect the security context under which the user of client system is operating, and store information from the client system into the repository. The present approach may provide for more efficient processing for storing information from a client device to a repository.

In some examples, instead of a specialized connection from a) the client device, running b) client software application, to c) centralized repository, a generalized connection is provided from d) the client device to e) the appliance described herein to f) the repository. The present approach may provide for 1) fewer, and possibly as few as one connection is needed, and 2) the connection provided by the present system and method may be usable for software applications not yet installed on the client device. Hence, the technical complexity, risk, and expense required to develop and maintain specialized connections may be replaced in some implementations by the lower complexity and risk of generalized, reusable connections as described herein.

In one example, a client user-mode mode driver is configured to operate with an appliance device or service to securely manage information in repositories in a manner that is simplified for the user. The client user-mode driver may be patterned after print drivers or other types of drivers that are familiar to users and integrated into the function of a client device. The appliance engages with authentication providers to authenticate users of a client device and communicate with the client user-mode driver and repositories to manage documents and information. Once a user is authenticated, the appliance identifies the available repositories and metadata needed for managing the documents and information for presentation to the authenticated user via the client user-mode driver. The user identifies a repository for the documents and information along with the required metadata. The subsequent print request from the user to the client user-mode driver may then result in the appliance committing the documents and information to the selected repository with defined metadata. An authenticated user may be able to simply and securely store, access and manage documents to one or more repositories that may reside in a complex of systems across networks through the use of the client user-mode driver and the appliance.

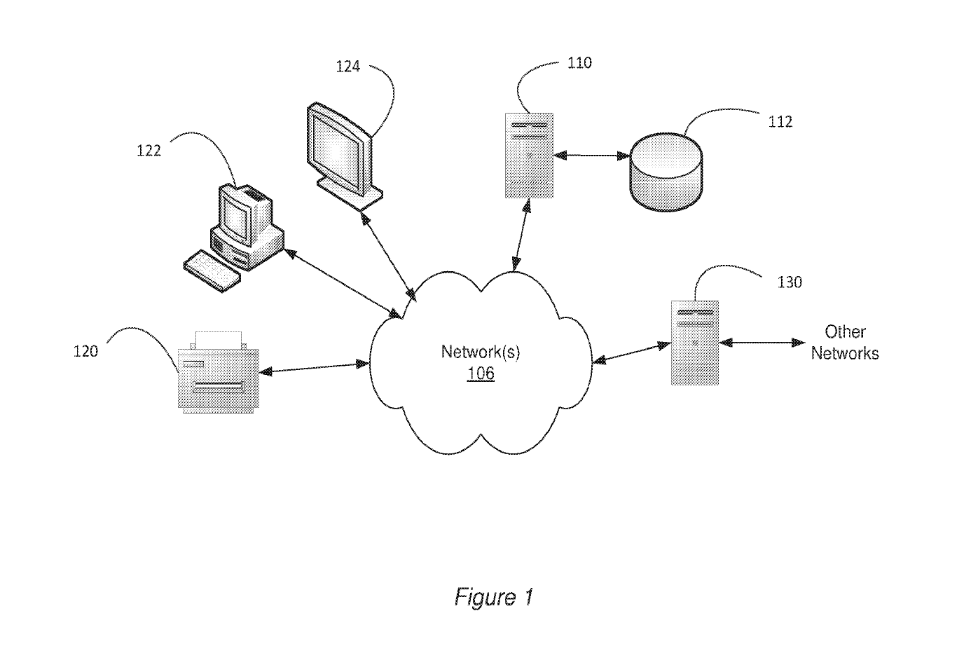

FIG. 1 is an architecture diagram that depicts aspects of an example of a computer network system with communication among multiple devices. In this example, network 106, which can be one network or multiple networks, provides communication between server 110 connected to database 112 and several client devices, such as printer 120, personal computer 122, and interactive terminal 124. The architecture of FIG. 1 is a simplified representation of an enterprise environment having a multitude of different computing devices that may represent a target for an attack. A gateway 130 provides a communications link between the network 106 and other networks, such as the internet, through which an attacker may launch an attack.

Data, such as documents and information, may be stored in repositories residing in various devices or servers distributed across one or more networks. For example, server 110 may include one or more repositories accessible through network 106. Additional repositories, such as repositories in cloud storage or remotely located repositories for an organization and/or its partner organizations may reside on other networks accessible via gateway 130. Client devices, such as devices 120, 122 and 124, are typically used to manage and access data in these repositories, such as creating, storing, editing and sharing of documents, often across multiple security domains. It is frequently desirable that such data be managed securely within and across security domains. Securely managing data in this context may become complex and present a challenge for many users. The present approach may simplify the interface for managing data in these contexts.

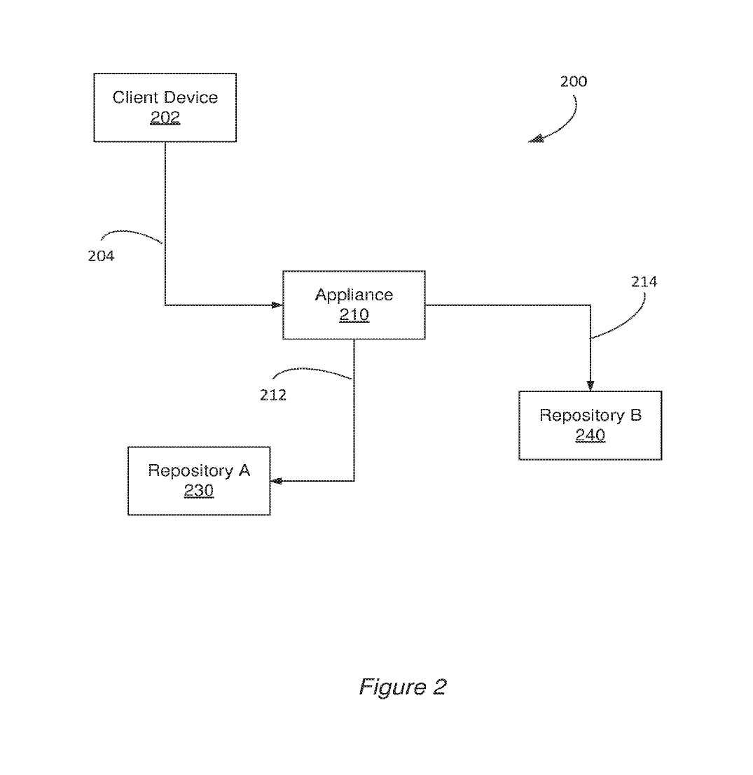

FIG. 2 is a schematic diagram depicting one example of an architecture 200 demonstrating certain aspects of the present system and method. In architecture 200, client device 202, which may be utilized by a user to create and access managed documents and other information, has a generalized connection 204 to, in this example, Appliance 210 in accordance with the present system and method. Appliance 210, in this example, has multiple connections 212 and 214 to repositories 230 and 240. Appliance 210 is configured to manage and control access and storage of documents and information in repositories 230 and 240 responsive to user requests from client device 202 received via generalized connection 204. Note that in some examples Appliance 210 may be a dedicated device, such as a server, or, in other examples, one or more server processes residing on one or more devices.

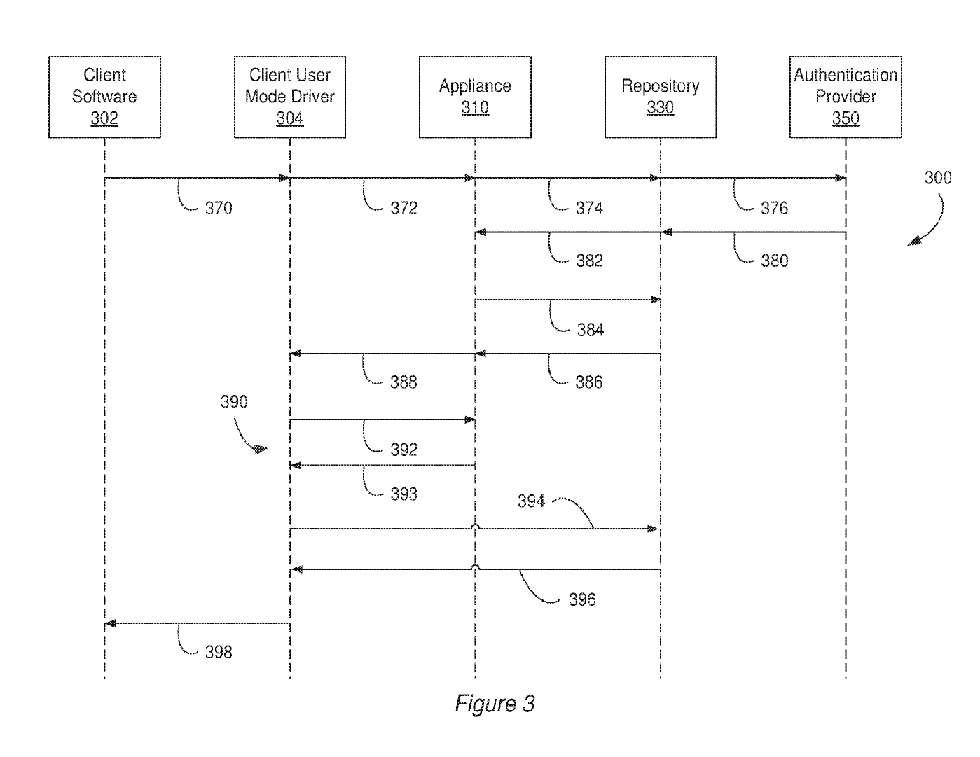

FIG. 3 is sequence diagram illustrating an example of an exchange of messages and information 300 in accordance with certain aspects of the present system and method. In the example of FIG. 3, a client user-mode software driver component is provided, e.g. provisioned in client device 202, that allows a user to initiate a generalized connection. The client software driver component is represented in the Sequence Diagram as “Client User-mode Driver” 304. An Appliance 310, which may be implemented as a software service or a device residing on the client device, is provided that receives requests from client device users and attempts to authenticate the user of the client device based on the user's security context. The Client User-mode Driver 304 may, for example, be a resource management interface of an operating system of the client device, which permits application programs active on the client device to view and select resources available on the client device, such as printers or storage devices. The client software 302 is able to access appliance 310 through the client user mode driver 304.

In the example of FIG. 3, client software 302, e.g. in client device 202, initiates a request to save information 370 sent to client user-mode driver 304 to appliance 310. In this example, request 370 contains the security context, such as the user's credentials, for the user of client software 302. The request to save information is passed by client user-mode driver 304 to the server appliance 310 in message 372 along with the security context. In response, server appliance 310 initiates an authentication request 374 to a destination repository 330 and destination repository 330 in turn requests authentication from an authentication provider 350.

If the authentication provider 350 validates the authentication request based on the user's security context, then it returns an authorization message 380 with the authenticated security context to destination repository 330, which, in turn, returns the authorization and security context to appliance 310 in message 382. Appliance 310 then formulates a request 384 for a list of destinations permissible for that security context (such as repository location names, and related optional and required meta-data for that repository location) and passes the request back to the repository 330 in message 384. Repository 330 returns the list of destination repositories to appliance 310 in message 386.

Appliance 310 then returns the destination list to the Client-mode user driver 304 in message 388. In this example, Client-mode user driver 304 displays the destination repository information as a platform-appropriate user interface dialog box 390. The user of client software 302 chooses a destination repository in a user interface dialog 390 and enters any required meta-data as well as any optional meta-data desired, followed by indicating to the client-mode user driver 304 that the information and document are ready to be stored in the selected destination repository. Client-mode user driver 304 then transmits the document and the meta-data, along with the security context, in message 392 to appliance 310. Appliance 310 in turn passes the document, meta-data and security context in message to the selected repository, which is repository 330 in this example, in message 394. The repository 330 stores the document and meta-data according to its functional rules and returns confirmation of the database commit in message 396 to Client-mode user driver 304, which confirms that the save was concluded in message 398 to client software 302.

In another example, the destination repository, acting as a Service Provider, has a Security Assertion Markup Language (SAML) 2.0 capability known as Web Browser Single Sign-on (SSO) Profile and the destination repository passes the authentication request to the authentication provider as a SAML 2.0 assertion. In this example, the authentication provider, acting as an Identity Provider, has the capability to receive and evaluate SAML 2.0 assertions.

The authentication provider responds in one of the following ways to the request for authentication: 1) If the request has been presented as a SAML 2.0 assertion, and the assertion is valid, an XML security token is returned: 2) Denied as invalid user: or 3) Unable to process SAML assertion. In the third scenario, the user is asked for their user identifier and password. If the user ID and password provided is accepted, then authentication is confirmed by message 380 and process 300 proceeds. If the user ID and password provided is not accepted, then authentication is denied in message 380 and process 300 does not proceed.

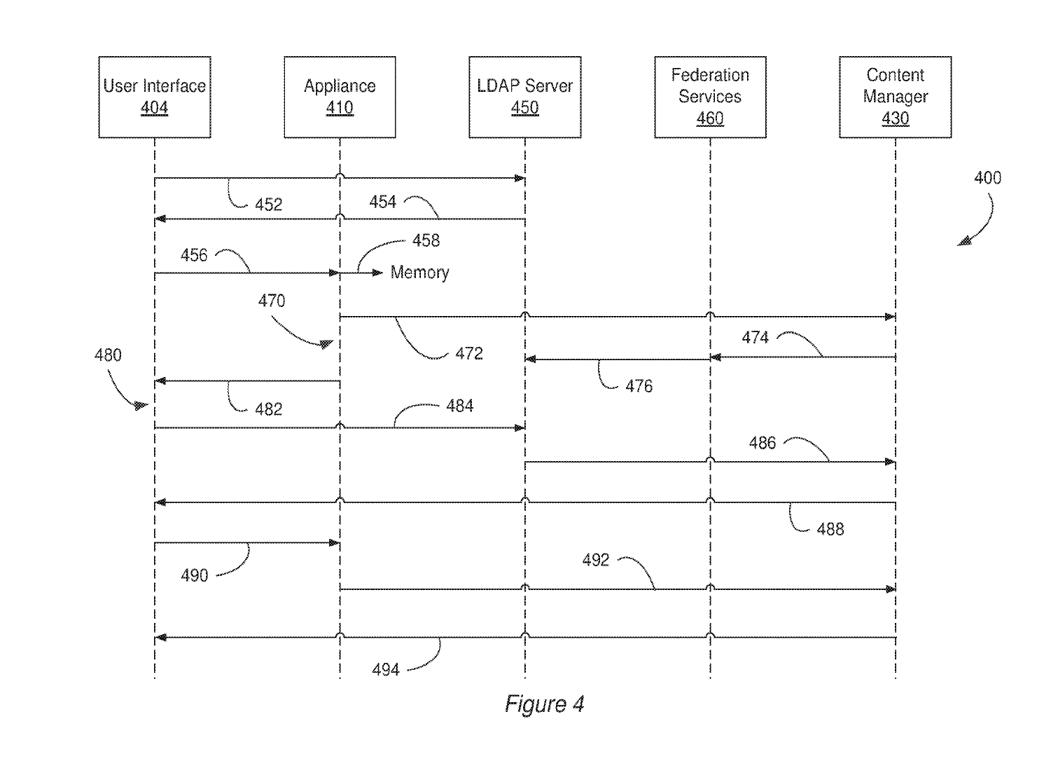

FIG. 4 is a sequence diagram illustrating another example of an exchange of messages and information 400 in accordance with certain aspects of the present system and method pertaining to federation services with single sign on (SSO) context where, in this example, a document may be committed to a repository as a print job submitted to appliance 410 using the present approach. In the example of FIG. 4, user interface 404 is used to login to a workstation client device, which results in a logon authentication request 452 being sent to Lightweight Directory Access Protocol (LDAP) Server 450, which stores usernames and passwords used to validate users, through Appliance 410. If the user's credentials in request 452 are authenticated, an authentication confirmation is sent at 454 through Appliance 410, where Appliance 410 maintains the user's credentials for the relevant security context.

A request by the user via user interface 404, e.g. Ctrl-p or activation of a print command, results in print request message 456 being sent to Appliance 410, which spools the print request in memory at 458. In a Single-sign-on (SSO) implementation 470, an SSO module in Appliance 410 sends a query 472 for available repositories to content manager 430 that includes the user's SSO credentials. Content manager 430 redirects the query at 474 to federation services 460 for authentication of the user's SSO credentials. Federation services 460 validates the user 476 with LDAP server 450. In a login form implementation 480, Appliance 410 initiates presentation of login form 482 to the user prompting the user to login. The credentials provided to Appliance 410 by the user via login form are sent to LDAP server 450 in message 484. In either case, LDAP server 450 validates the user's credentials (such as through Federated Services 460, which provides authenticated access for a user to multiple security realms or contexts) and sends a user authorization message 486 to content manager 430, which retrieves the available repositories and, in one example, metadata defined as required for the document in message 488 for presentation to the user in user interface 404.

The user sets a desired repository and provides the required metadata via user interface 404, which is sent to Appliance 410 in message 490. Appliance 410 then sends the document with the minetadata in a commit request 492 to the selected repository, which resides in content server 430 in this example, and content server 430 returns a successful commit indication in message 494 through Appliance 410 to user interface 404 for display to the user.

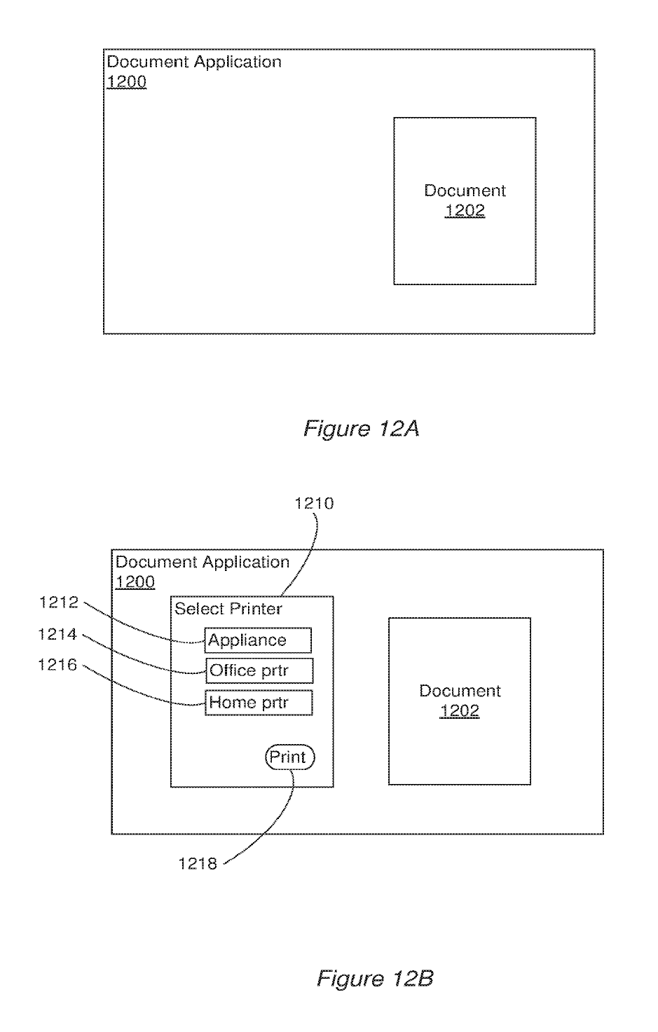

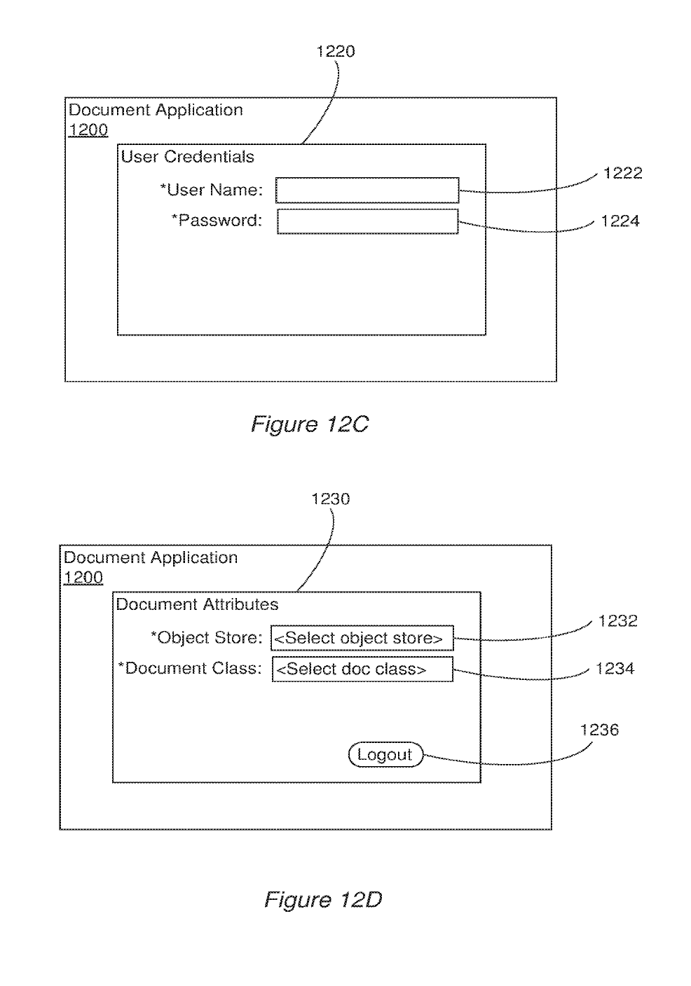

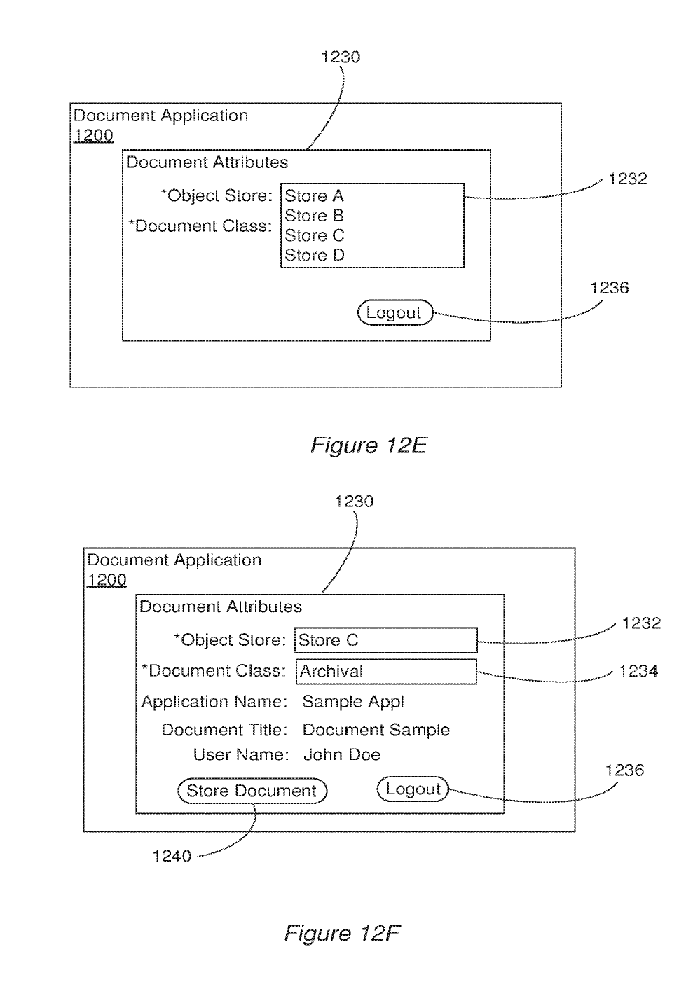

In one example, the client user-mode driver may appear to the user as a print driver. The client user-mode print driver may be installed on the client device in a manner similar to other print device drivers and, thereafter, the client user-mode driver may appear as an option to the user when the user attempts to print a document and activates a print user-interface window. A user interface window provided, for example, during driver installation may prompt the user for the user's SSO credentials, to select a repository for documents associated with the driver, and define any metadata needed by the repository. Thereafter, a print action by the user using the client user-mode print driver may result in the appliance committing the document to the selected repository with the defined metadata. FIGS. 12A-F illustrate an example of the user interface window for such a print driver implementation.

In another example, the client user-mode driver may provide to the user a web browser interface to the appliance, which prompts the user to provide the user's credentials for one or more security contexts. Once the user is validated for a security context, the appliance obtains the repositories available to the user within the security context along with the required metadata for the repositories and prompts the user through the web interface to select a repository and define the metadata for the repository. When a user prints a document within the security context, a print request is sent to the appliance, which commits the document to the selected repository with the defined metadata and may provide the user with a success indicator when the commit is concluded. One of ordinary skill in the art will readily recognized that other combinations and variations may be utilized that are consistent with the present approach that fall within the present teachings.

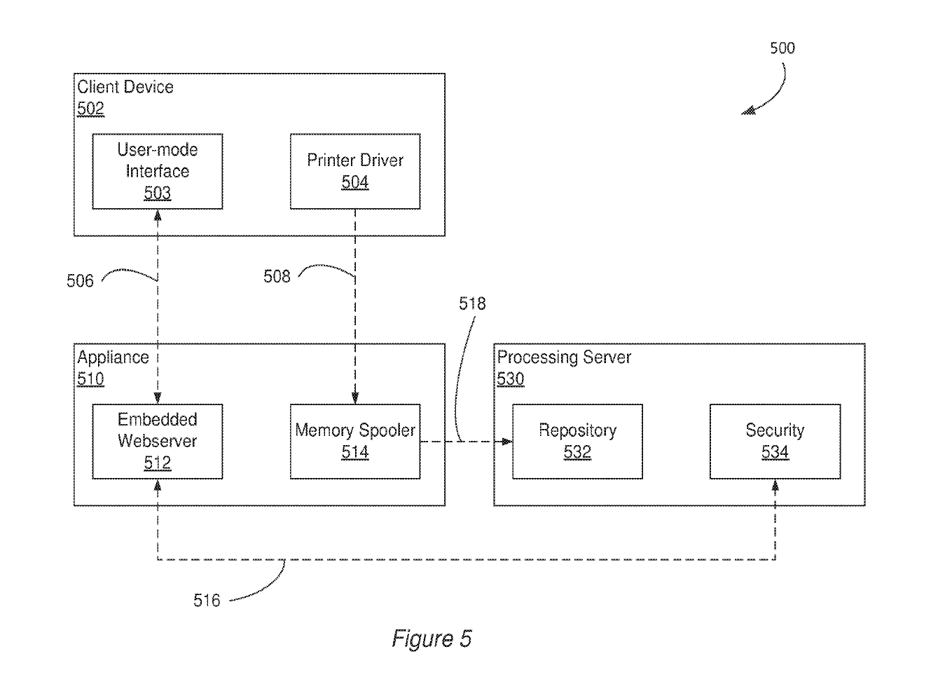

FIG. 5 is an architecture diagram illustrating an example of a client device 502 with a client user-mode interface 503 and print driver 504 configured as described herein with communication channels to appliance 510. Appliance 510 has been configured with the user credentials to authenticate the user, e.g. by SSO or through user mode interface 503 using embedded webserver 512, which are provided to security domain 534 through communications channel 516. Security domain 534 authenticates the user credentials for one or more security contexts and provides information via channel 516 that identifies one or repositories on content or processing server 530 that are accessible to the user based on the security context, which is provided to user mode interface 503 via channel 506. User mode interface 503 presents the available repositories to the user, receives the user's selection of a repository. A document print operation involving print driver 504 results in the document being sent to appliance 510, which commits the document to the selected repository in server 530 within one or more security contexts established for the user of print driver 504.

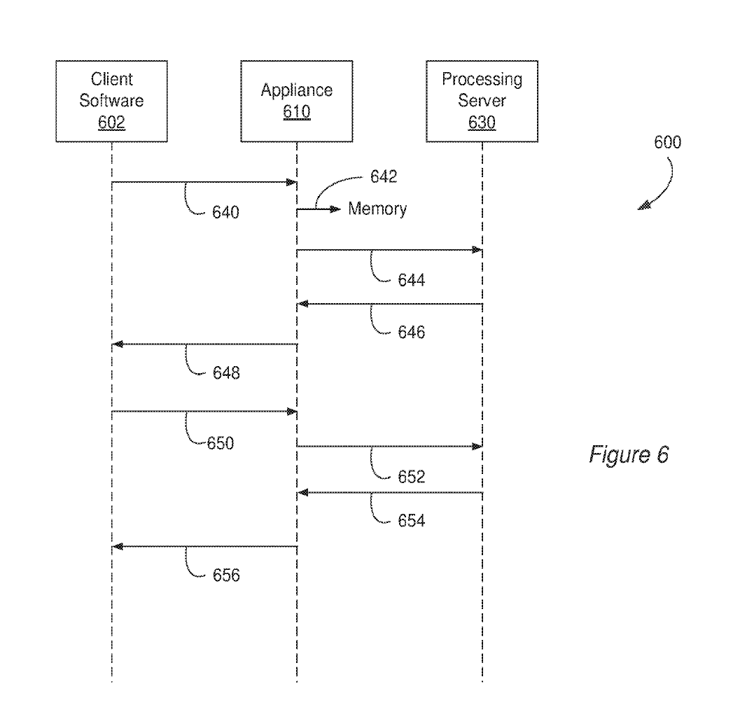

FIG. 6 is a simplified sequence diagram illustrating one example 600 of messaging and processing in the architecture of FIG. 5. In this example, a user of client device 602 requests a print job for a document resulting in the print driver sending a first message 650 from the client 602 to appliance 610. Appliance 610 spools the print job to memory 642 and sends an inquiry 644 to content or processing server 630 with the user's credential to validate the User Security. Processing server 630 validates the user's credentials for a security context, identifies repositories available to the user with the security context along with any required or optional metadata for filing the document. This information is sent in a message 646 from server 630 to appliance 610, which, in turn, sends the repository and metadata information to client device 602 in message 648 for display to the user in the form, in this example, of a web browser interface, such as an interface provided to the user by user mode interface 503 operating with embedded webserver 512, for example. Through the web browser interface of appliance 610, the user selects one or more of the identified repositories to receive and manage the document and defines metadata for filing the document at 650. The user selections along with the spooled document are sent as a print job 652 from appliance 610 to the selected repository in server 630, which commits the document to the repository and sends confirmation 654 to appliance 610. Appliance 610 presents an indicator 656 to the user that the document was successfully committed to the repository.

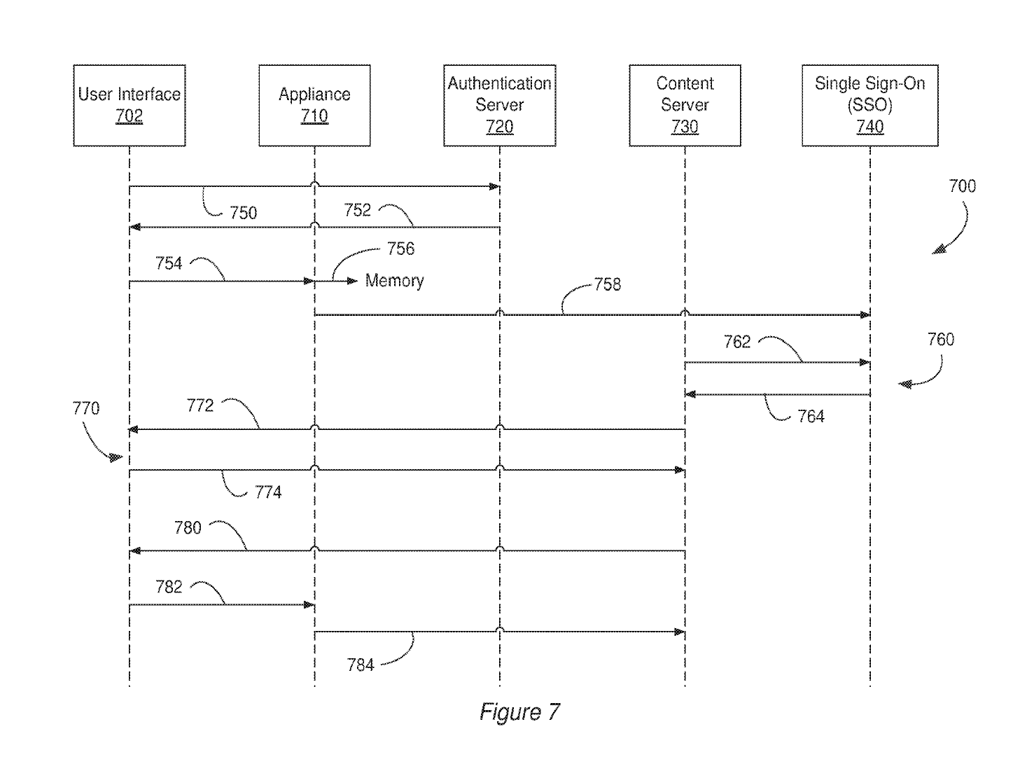

FIG. 7 is another sequence diagram illustrating examples of messaging for a print job for a document in accordance with certain aspects of the present approach in both a SSO context and a non-SSO context. As described previously, a user interface 702 of a client device is used by a user to present their credentials 750 to authentication server 720, which authenticates the user's credentials and indicates a successful logon 752. When the user submits a print request 754 to a print driver associated with Appliance 710, the document is spooled to memory 756 and a query for available repositories 758 is sent to content server 730.

In a SSO context 760, where the user's credentials have been authenticated for the security context, the content server 730 will send the user's credentials in in message 762 to SSO service 740, which validates the credentials and returns user authorization 764. In a non-SSO context 770, e.g. the user's credentials do not correspond to an authenticated SSO identity, the repository 730 sends message 772 that causes the user interface 702 to prompt the user for the user's credentials 774, which are used to authenticate the user with authentication server 720 and obtain authorization to access to the repository 730.

Once the user's credentials are authenticated in either the SSO context 760 or non-SSO context 770, content server 730 sends message 780 indicating the repositories available to the user within the authenticated security context or contexts, which are displayed to the user through user interface 702. In some examples, message 780 may also indicate meta-data that is required or optional for the repositories. Using user interface 702, the user selects a repository as the object store for the document and defines metadata for the document, which is sent to appliance 710 at 782. Appliance 710 then send a commit message 784 with the document and meta-data pertaining to the document to content server 730, which stores the document and meta-data to the selected repository.

In a federated context, users are provided with single sign on (SSO) access to systems and applications located in multiple security contexts, e.g. systems and services belonging to different organizations. A federation service, such as Active Directory Federation Services (ADFS), establishes trust between one or more security realms. A federation server on one side (the Accounts side) authenticates the user through the standard means in Active Directory Domain Services and then issues a token containing a series of claims about the user, including its identity. On the other side, the Resources side, another federation server validates the token and issues another token for the local servers to accept the claimed identity. This allows a system to provide controlled access to its resources or services to a user that belongs to another security realm without requiring the user to authenticate directly to the system and without the two systems sharing a database of user identities or passwords.

In a non-federated context, an organization may have users, for example, agents who are not employees who use devices that are not joined to the security domain (i.e. Active Directory), and they are not on the organization's network (e.g. use of the public internet to access web, email, applications, etc.). In an example of this scenario, the printer driver would have a configuration setting to connect to the appliance on a public URL like https://mydocs.university.edu. When the agent needs to send a document using the present approach to the organization, the printer driver connects to the URL and presents an appliance-hosted login screen requesting user identifier and password. The organization may select one of a variety of authentication mechanisms, such as OAuth, mail service providers, application service providers, social network providers, etc. Once the agent logs in, the appliance would send the appropriate destination storage details, such as repository, doc class, required fields, optional fields, etc. based on their permissions for their login. The user would fill in the properties and then save the document.

One aspect of the present approach is that the driver/appliance architecture may provide a configuration-only integration from a client application that can print to an organization's repositories, even client applications that don't exist yet. This may, in some examples, be accomplished using minor configurations with little to no dedicated programming. Conventional solutions typically require significant Application Program Interface (API) development. For example, existing “print to pdf” solutions don't solve the problem of “where should the document go?”

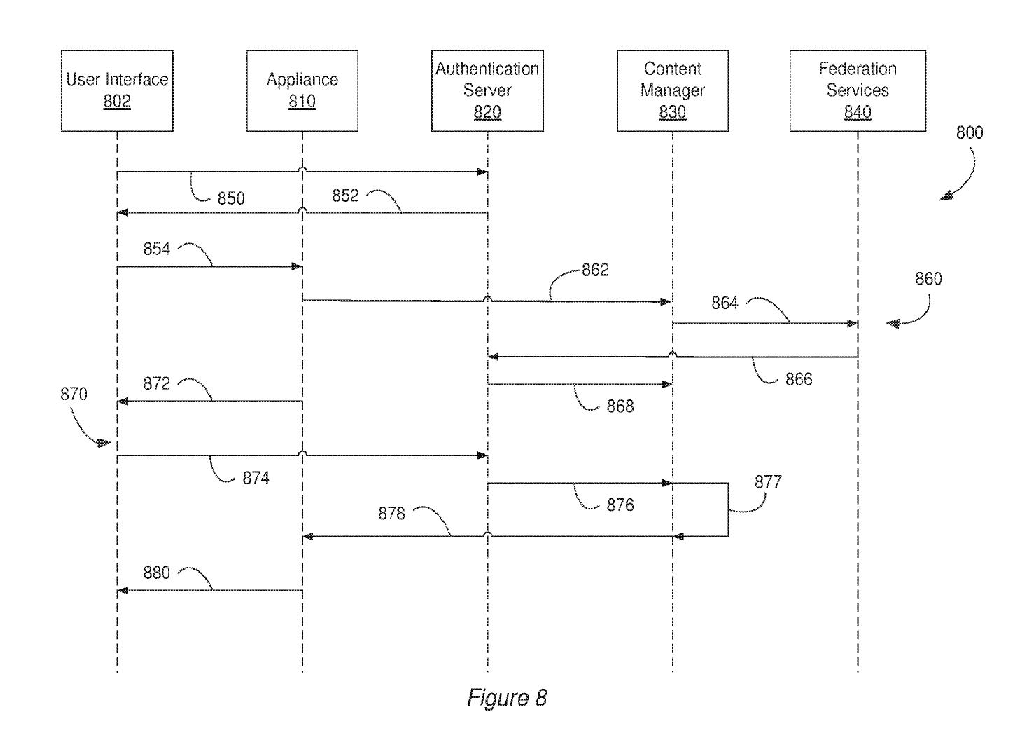

FIG. 8 is a sequence diagram illustrating an example of a scenario 790 for querying or browsing for documents in accordance with certain aspects of the present approach involving federated services. As discussed above, a user has successfully signed on to a workstation using a user interface 802, where LDAP Server 820 has authenticated the user's credentials. In this scenario, instead of the user requesting a print job to commit a document or information to a repository, the user sends a request 854 to search or browse for documents that may be in a repository to Appliance 810. In an SSO context, appliance 810 finds the user's SSO credentials and submits them with the query in message 862 to content manager 830, which sends a query 864 with the SSO credentials to federation services 840 for user validation. If the federation services 840 validate the user, a user validation message 866 is sent to LDAP server 820, which, in turn, sends message 868 to content manager 830 to indicating that the user is validated and providing the authorized security context for the user. Content manager 830 searches the repositories authorized for the user's credentials and returns the result set in message 878 to appliance 710, which forwards the results in message 880 to user interface 802 for display to the user.

In a non-SSO context 870, appliance 810 does not have the SSO credentials for the user, so it prompts the user 872 through user interface 802 for their login credentials and submits 874 the credentials provided by the user to Authentication server 820, such as an LDAP server, for validation. If the user is validated, then Authentication server 820 notifies the content manager 830 in message 876 with the authorized security context for the user. Content manager 830 searches for the repositories authorized for the user's credentials and returns the result set in message 878 to appliance 810 for display to the user.

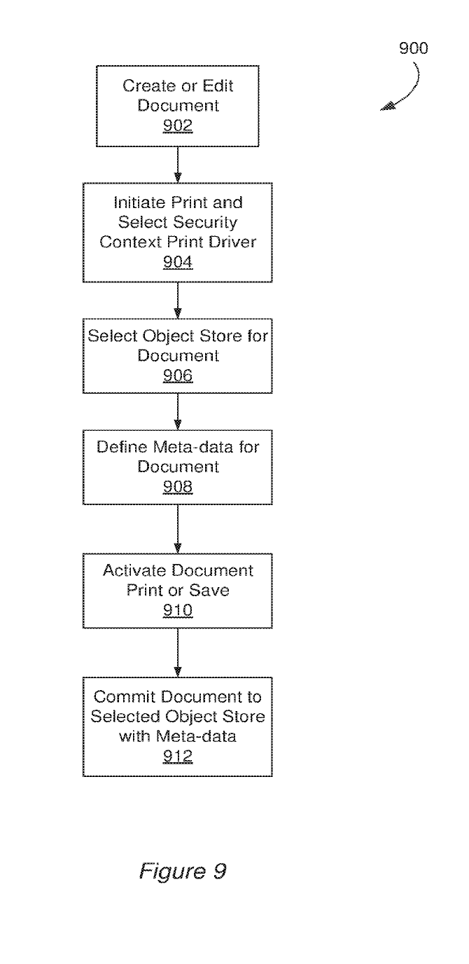

FIG. 9 is a control flow diagram illustrating one example of a process 900 executed on a client device for storing a document in accordance with certain aspects of the present approach, where the appliance service appears to the user as a printer device. In this example, at step 902, a document is created or edited using an application program executing on a client device. At step 904, through a user interface provided by the client device, a user initiates a print operation for the document, e.g. Ctrl-P or otherwise selecting a print operation, and selecting a security context print driver, such as the Appliance discussed above. In this example, at step 906, the user is prompted to select an object store for the document, such as an object store identified in a list of stores or repositories available to the user in one or more of the user's security contexts. At step 910, the user may be prompted to define meta-data for the document, where the meta-data may be required or optional for the security context for the store or repository selected at step 906. At step 910, the user actives the print or, alternatively, save operation, for the document via the user interface of the client device. At step 912, the document is committed to the selected object store or repository with the meta-data for the document for storage by the selected object store or repository.

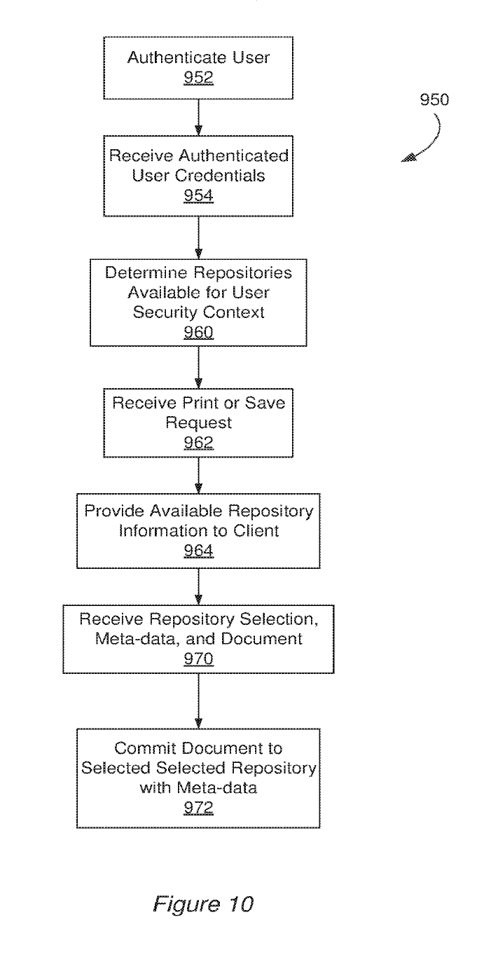

FIG. 10 is a control flow diagram illustrating another example of a process 950, executing in an appliance service or device, for storing a document in accordance with certain aspects of the present approach, where the appliance service authenticates the user, identifies repositories available to the user within the established security context and presents the identified repositories to the user for selection. At step 952, the user is prompted to provide user credentials through a user interface of a client device and the user credentials input by the user are received at step 954. In an alternative SSO context, the user credentials are SSO user credentials. At step 960, the repositories or object stores available to the user within one or more of the user's security contexts is determined, such as by querying a content server or service that hosts the repositories or object stores or serves as a management interface to the repositories or object stores.

At step 962, a print or save request is received for a document and, at step 964, the available repositories or object stores is provided for display to the user through a user interface. At step 970, the user's selection of a repository or object store is received along with the document and meta-data pertaining to the document. At step 972, the document and meta-data is communicated to the selected repository or object store for storage within the user's security context.

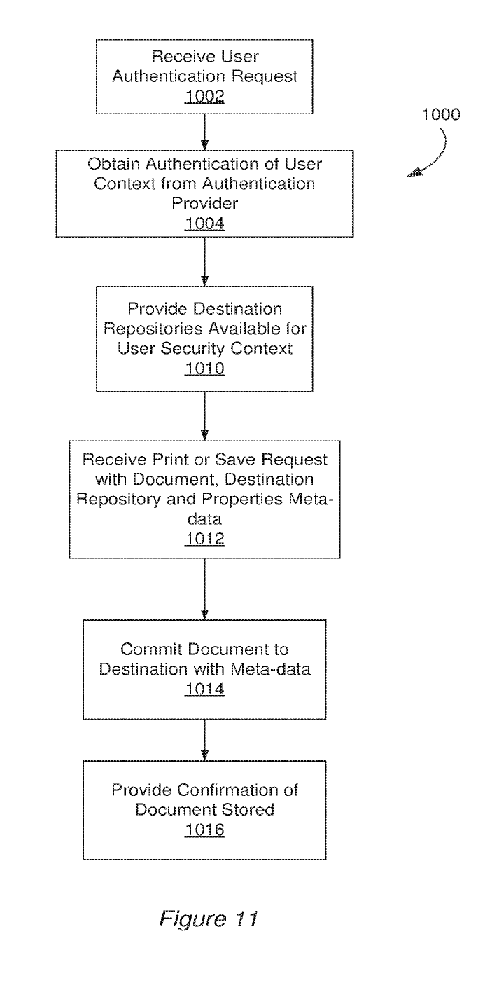

FIG. 11 is a control flow diagram illustrating an example of a process 1000, such as a process executing, at least in part, in a content manager service, for storing a document in accordance with certain aspects of the present approach, where the user is authenticated by an authentication provider, a list of repositories available to the user within the established security context is determined and provided, and a save or print request is received with a document, a destination repository, and meta-data pertaining to the document. At step 1002, a user authentication request is received, such as from an authentication service, and, at step 1004, authentication of the user's credentials and the user's security context are obtained from an authentication provider. At step 1010, the repositories available to the user with the security context are provided to, for example, an appliance service. At step 1012, a print or save request is received with a document, a destination repository identified, and meta-data pertaining to the document. At step 1014, the document and metadata are committed to the destination repository for storage and, at step 1016, confirmation that the document has been stored is provided.

FIGS. 12A-F are schematic diagrams illustrating an example of user interfaces provided through a user interface on a client device for a scenario wherein a document is stored in accordance with certain aspects of the present approach. In FIG. 12A, a document application 1200 on the client device is utilized to create a document 1202. In FIG. 12B, a resource management interface 1210 of an operating system of the client device offers the user an Appliance driver 1212, an Office printer driver 1214, and a Home printer driver 1216 for selection along with a virtual Print button 1218 that a user selects to initiate a print request. Examples of resource management interfaces include an operating system file management interface window that identifies local and remote storage devices and services available to the user of the client device, an operating system device management interface window that identifies devices available on the client device, such as printers, or a print or save window accessible through a word processing application or other content creation application. One of ordinary skill in the art, as well as many users, will be familiar with such interfaces and similar interfaces commonly available on client devices.

In FIG. 12C, an example of a user interface 1220 is shown for the appliance service to prompt the user for user credentials, such as upon activation of the Print button 1218 in FIG. 12B. User interface 1220 provides the user with a name entry field 1222 and a password entry field 1224, which the user uses to submit their user credentials.

In FIG. 12D, a user interface 1230 for the appliance service presents object stores available to the user in the security context established with the user credentials obtained in FIG. 12C. In this example, the object stores are made available to the user in a drop-down menu of object store entry field 1232 and document classes for the document are made available to the user in a drop-down menu of document class in document class entry field 1234. A logout button 1236 is offered for the user to logout and exit the security context. FIG. 12E illustrates the drop-down menu for object store entry field 1232, which shows four available destination repositories: Store A, Store B, Store C and Store D. These available stores may correlate to multiple security contexts. For example, Store A may be associated with an accounting document repository while Store B is associated with a human resources document repository. The user selects an entry in the drop-down menu to populate object store entry field 1232.

FIG. 12F illustrates an example of user defined entries for user interface 1230 for the appliance service. In this example, the user selected Store C as the destination repository for the document, defined the document class as Archival. Additional meta-data for the document may include the application name, the document title and the user name requesting storage of the document, some of which may be defined by the user in some examples and some of which may also be defined by the application service in other examples. A Store Document button 1240 is provided for the user to initiate storage of the document and meta-data in the selected object store Store C.

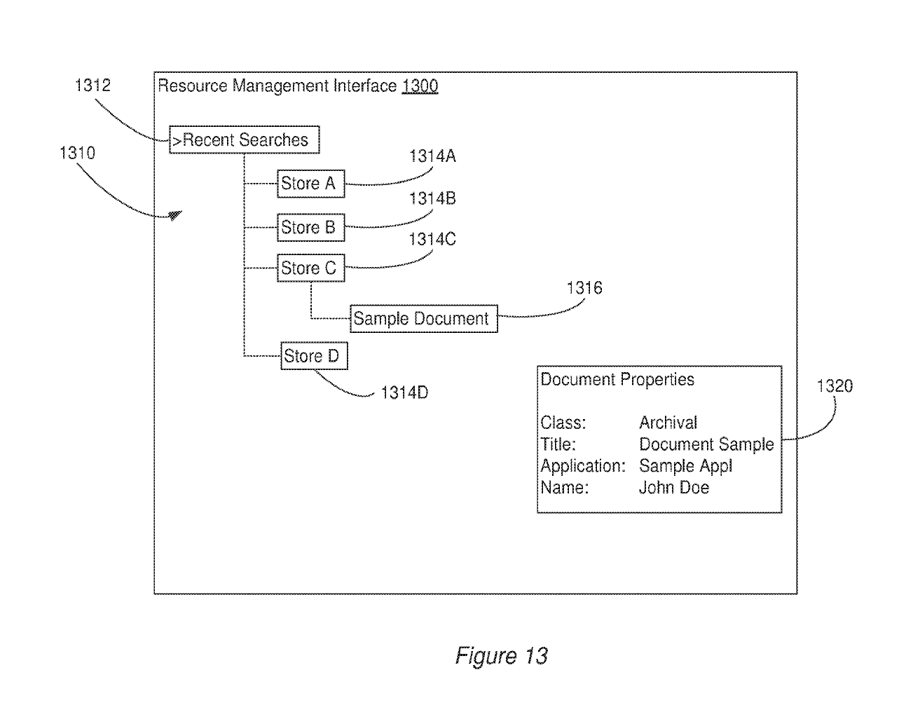

FIG. 13 is a schematic diagram illustrating an example of a resource management interface 1300 of an operating system illustrating a directory structure showing the storage of the sample document in the selected repository along with the meta-data pertaining to the document sample in the example of FIGS. 12A-F in accordance with certain aspects of the present approach. In this example, the resource management interface 1300 shows recently accessed storage devices in a graphical directory structure 1310 under a recent searches tab 1312. The graphical directory structure 1310 shows the object stores and, in particular, shows the Sample Document stored in the example of FIGS. 12A-F as residing in object store C shown in the directory structure as icon 1314C. In this example, selection of the Sample Document icon 1316 activates a Document Properties window 1320 that shows the meta-data for the Sample Document. One of ordinary skill in the art will recognize that there are a wide variety of different examples of the operating system resource management interface 1300 that may be employed.

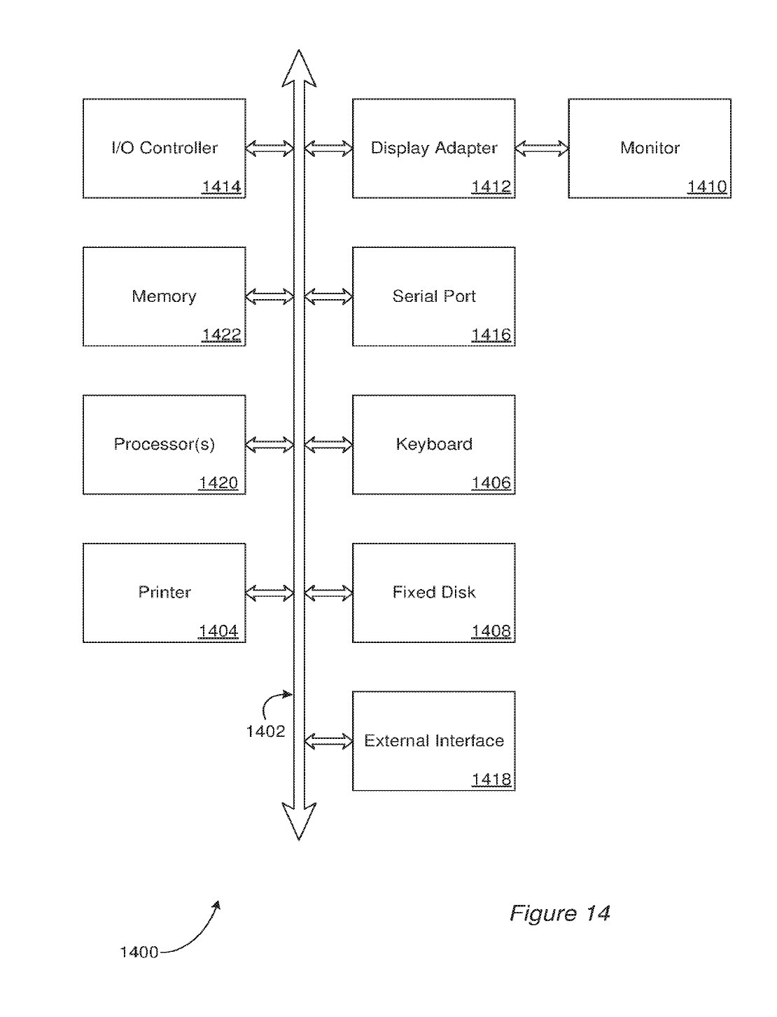

FIG. 14 depicts aspects of elements that may be present in a computer device and/or system configured to implement a method, system and/or process in accordance with some embodiments of the present invention.

In accordance with at least one embodiment of the invention, the system, apparatus, methods, processes and/or operations for providing access to a proximate device from a mobile device may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system.

As an example, FIG. 14 depicts aspects of elements that may be present in a computer device and/or system 1400 configured to implement a method and/or process in accordance with some embodiments of the present invention. The subsystems shown in FIG. 20 are interconnected via a system bus 1402. Additional subsystems include a printer 1404, a keyboard 1406, a fixed disk 1408, and a monitor 1410, which is coupled to a display adapter 1412. Peripherals and input/output (1/O) devices, which couple to an I/O controller 1414, can be connected to the computer system by any number of means known in the art, such as a serial port 1416. For example, the serial port 1416 or an external interface 1418 can be utilized to connect the computer device 1400 to further devices and/or systems not shown in FIG. 14 including a wide area network such as the Internet, a mouse input device, and/or a scanner. The interconnection via the system bus 1402 allows one or more processors 1420 to communicate with each subsystem and to control the execution of instructions that may be stored in a system memory 1422 and/or the fixed disk 1408, as well as the exchange of information between subsystems. The system memory 1422 and/or the fixed disk 1408 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl or using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following examples:

### Example 1

A method for storing documents in a content management service, the method comprising: disposing an appliance service (210) on a client device (202); establishing (374, 376, 380, 382) a security context for a user of the client device, where the security context is established between the appliance service and the content management service (330); presenting the appliance service (388) as an option in an operating system resource management user interface; receiving a user document storage command (370) to the appliance service indicating that a document is to be stored; and responsive to receiving the user document storage command, sending a document storage command (394) with the document from the appliance service to the content management service for storage in the security context for the user.

### Example 2

The method of Example 1, wherein the appliance service is preconfigured with the content management service for the security context for the user.

### Example 3

The method of Example 2, wherein the appliance service is predefined with meta-data and the document storage command includes the predefined meta-data.

### Example 4

The method of Example 1, where the method further includes: presenting to the user one or more content management service options available to the user in the security context; receiving a user selection of a selected one of the content management service options; and where the step of sending a document storage command with the document from the appliance service to the content management service for storage in the security context for the user comprises sending a document storage command with the document from the appliance service to the selected one of the content management service options for storage in the security context for the user.

### Example 5

The method of Example 4, the method further including: prompting the user for meta-data pertaining to the document: receiving user defined meta-data pertaining to the document; and where the step of sending a document storage command with the document from the appliance service to the content management service for storage in the security context for the user comprises sending a document storage command with the document and the user defined meta-data from the appliance service to the selected one of the content management service options for storage for storage of the document and the user defined meta-data.

### Example 6

The method of Example 4, the method further including querying the content management service to obtain the one or more content management service options available to the user in the security context.

### Example 7

The method of Example 1, the method further including: prompting the user for user credentials; receiving the user credentials; and responsive to receiving the user credentials, authenticating the user credentials with an authentication service.

### Example 8

The method of Example 1, the method further including: obtaining the user's single sign on (SSO) credentials; and authenticating the user's SSO credentials with an authentication service.

### Example 9

The method of Example 1, wherein: the step of presenting the appliance service as an option in an operating system resource management user interface comprises presenting the appliance service as a printer device option in an operating system device management user interface: the user document storage command to the appliance service indicating that a document is to be stored comprises a user print command indicating that the document is to be printed; and the step of sending a document storage command with the document from the appliance service to the content management service comprises sending a document storage command with a portable document format (PDF) version of the document from the appliance service to the content management service for storage in the security context for the user.

### Example 10

The method of Example 1, wherein: the step of presenting the appliance service as an option in an operating system resource management user interface comprises presenting the appliance service as a file storage option in an operating system file management user interface; the user document storage command to the appliance service indicating that a document is to be stored comprises a user document save command indicating that the document is to be saved to the appliance service file storage option; and the step of sending a document storage command with the document from the appliance service to the content management service comprises sending a document storage command with a native version of the document from the appliance service to the content management service for storage in the security context for the user.

### Example 11

The method of Example 1, where the content management service includes one or more repositories, each repository being capable of saving documents.

### Example 12

The method of Example 1, the method further includes: receiving the document storage command and the document in the content management service; and responsive to receiving the document storage command and the document in the content management service, storing the document in a repository of the content management service available to the user under the security context for the user.

### Example 13

A computer storage medium having computer executable instructions stored thereon which, when executed by one or more processors, cause the one or more processors to operate to: provide an appliance service (310) that establishes (374, 376, 380, 382) a security context with a content management service (330) for a user; present the appliance service (388) as an option in an operating system resource management user interface; receive a user document storage command (370) to the appliance service indicating that a document is to be stored; and responsive to receiving the user document storage command, the appliance service communicates (394) the document to the content management service for storage in the security context for the user.

### Example 14

The computer storage medium of Example 13, wherein the appliance service is preconfigured with the content management service for the security context for the user.

### Example 15

The computer storage medium of Example 14, wherein the appliance service is predefined with meta-data and the appliance service operates to automatically communicate the predefined meta-data to the content management service for storage with the document.

### Example 16

The computer storage medium of Example 13, the medium further including computer executable instructions stored thereon which, when executed by the one or more processors, cause the one or more processors to operate such that the appliance service functions to: present to the user one or more content management service options available to the user in the security context; receive a user selection of a selected one of the content management service options; and wherein, responsive to receiving the user document storage command, automatically communicate the document to the selected one of the content management service options for storage in the security context for the user.

### Example 17

The computer storage medium of Example 16, the medium further including computer executable instructions stored thereon which, when executed by the one or more processors, cause the one or more processors to operate such that the appliance service functions to: prompt the user for meta-data pertaining to the document; receive user defined meta-data pertaining to the document; and wherein, responsive to receiving the user document storage command, automatically communicate the user defined meta-data pertaining to the document to the selected one of the content management service options for storage for storage with the document.

### Example 18

The computer storage medium of Example 16, the medium further including computer executable instructions stored thereon which, when executed by the one or more processors, cause the one or more processors to operate such that the appliance service functions to query the content management service for the one or more content management service options available to the user in the security context.

### Example 19

The computer storage medium of Example 13, the medium further including computer executable instructions stored thereon which, when executed by the one or more processors, cause the one or more processors to operate such that the appliance service establishes the security context for the user by operating to: prompt the user for user credentials; receive the user credentials: and responsive to receiving the user credentials, authenticate the user credentials with an authentication service.

### Example 20

The computer storage medium of Example 13, the medium further including computer executable instructions stored thereon which, when executed by the one or more processors, cause the one or more processors to operate such that the appliance service establishes the security context for the user by operating to: obtain the user's single sign on (SSO) credentials; and authenticate the user's SSO credentials with an authentication service.

### Example 21

The computer storage medium of Example 13, wherein: the instructions that cause the one or more processors to execute to present the appliance service as an option in an operating system resource management user interface comprise instructions that cause the one or more processors to operate to present the appliance service as a printer device option in an operating system device management user interface: the user document storage command to the appliance service indicating that a document is to be stored further comprises a user print command indicating that the document is to be printed: and the instructions that cause the one or more processors to execute to, responsive to receiving the user document storage command, the appliance service communicates the document to the content management service for storage in the security context for the user comprise instructions that cause the one or more processors to operate to, responsive to receiving the user print command, the appliance service communicates a portable document format (PDF) version of the document to the content management service for storage in the security context for the user.

### Example 22

The computer storage medium of Example 13, wherein: the instructions that cause the one or more processors to execute to present the appliance service as an option in an operating system resource management user interface comprise instructions that cause the one or more processors to operate to present the appliance service as a file storage option in an operating system file management user interface; the user document storage command to the appliance service indicating that a document is to be stored further comprises a user document save command indicating that the document is to be saved to the appliance service file storage option; and the instructions that cause the one or more processors to execute to, responsive to receiving the user document storage command, the appliance service communicates the document to the content management service for storage in the security context for the user comprise instructions that cause the one or more processors to operate to, responsive to receiving the user document save command, the appliance service communicates a native version of the document to the content management service for storage in the security context for the user.

### Example 23

A client device, the client device comprising: a processor (1420); a display (1412): a user input device (1406); and a memory (1422) in communication with the processor, the memory having computer-readable instructions stored thereupon that, when executed by the processor, cause the processor to operate to: provide an appliance service (310) that establishes (374, 376, 380, 382) a security context with a content management service (330) for a user of the client device; present the appliance service (388) on the display as an option in an operating system resource management user interface; receive a user document storage command (370) from the user input device indicating that a document is to be stored; and responsive to receiving the user document storage command, sending a document storage command (394) with the document from the appliance service to the content management service for storage in the security context for the user.

### Example 24

The client device of Example 23, wherein the appliance service is preconfigured with the content management service for the security context for the user.

### Example 25

The client device of Example 24, wherein the appliance service is predefined with meta-data and the appliance service operates to automatically communicate the predefined meta-data to the content management service for storage with the document.

### Example 26

The client device of Example 23, where the memory further includes computer executable instructions stored thereon which, when executed by the one or more processors, cause the one or more processors to operate such that the appliance service functions to: present to the user one or more content management service options available to the user in the security context; receive a user selection of a selected one of the content management service options; and wherein, responsive to receiving the user document storage command, automatically communicate the document to the selected one of the content management service options for storage in the security context for the user.

### Example 27

The client device of Example 26, where the memory further includes computer executable instructions stored thereon which, when executed by the one or more processors, cause the one or more processors to operate such that the appliance service functions to: prompt the user for meta-data pertaining to the document; receive user defined meta-data pertaining to the document: and wherein, responsive to receiving the user document storage command, automatically communicate the user defined meta-data pertaining to the document to the selected one of the content management service options for storage for storage with the document.

### Example 28

The client device of Example 26, where the memory further includes computer executable instructions stored thereon which, when executed by the one or more processors, cause the one or more processors to operate such that the appliance service functions to query the content management service for the one or more content management service options available to the user in the security context.

### Example 29

The client device of Example 23, where the memory further includes computer executable instructions stored thereon which, when executed by the one or more processors, cause the one or more processors to operate such that the appliance service establishes the security context for the user by operating to: prompt the user for user credentials; receive the user credentials; and responsive to receiving the user credentials, authenticate the user credentials with an authentication service.

### Example 30

The client device of Example 23, where the memory further includes computer executable instructions stored thereon which, when executed by the one or more processors, cause the one or more processors to operate such that the appliance service establishes the security context for the user by operating to: obtain the user's single sign on (SSO) credentials: and authenticate the user's SSO credentials with an authentication service.

### Example 31

The client device of Example 23, wherein: the instructions that cause the one or more processors to execute to present the appliance service as an option in an operating system resource management user interface comprise instructions that cause the one or more processors to operate to present the appliance service as a printer device option in an operating system device management user interface; the user document storage command to the appliance service indicating that a document is to be stored further comprises a user print command indicating that the document is to be printed: and the instructions that cause the one or more processors to execute to, responsive to receiving the user document storage command, the appliance service communicates the document to the content management service for storage in the security context for the user comprise instructions that cause the one or more processors to operate to, responsive to receiving the user print command, the appliance service communicates a portable document format (PDF) version of the document to the content management service for storage in the security context for the user.

### Example 32

The client device of Example 23, wherein: the instructions that cause the one or more processors to execute to present the appliance service as an option in an operating system resource management user interface comprise instructions that cause the one or more processors to operate to present the appliance service as a file storage option in an operating system file management user interface; the user document storage command to the appliance service indicating that a document is to be stored further comprises a user document save command indicating that the document is to be saved to the appliance service file storage option; and the instructions that cause the one or more processors to execute to, responsive to receiving the user document storage command, the appliance service communicates the document to the content management service for storage in the security context for the user comprise instructions that cause the one or more processors to operate to, responsive to receiving the user document save command, the appliance service communicates a native version of the document to the content management service for storage in the security context for the user.

### Example 33

A system for managing documents in a security context, the system comprising: a client device that includes: an operating system having a resource management user interface that provides user access to resources residing on the client device including at least one of a file and a device: and an appliance service (310) that appears as an available option in the resource management user interface, where the appliance service is configured to: authenticate (374, 376, 380, 382) a user of the client device with an authentication service (350), where, once the user is authenticated for a security context, the appliance service identifies a content management service (330) available to the user within the security context, receive from the user a document storage request (370) that identifies a document, and commit (394) the document to the content management service.

### Example 34

The system of Example 33, wherein the appliance service is further configured to authenticate the user of the client device by prompting the user for user credentials, receiving the user credentials, and communicating the user credentials to the authentication service.

### Example 35

The system of Example 33, wherein the appliance service is further configured to authenticate the user of the client device by obtaining single sign-on (SSO) credentials for the user and communicating the SSO credentials to the authentication service.

### Example 36

The system of Example 33, wherein the appliance service comprises a print driver that is integrated into the client device.

### Example 37

The system of Example 33, wherein the appliance service is further configured to: identify one or more repositories of the content management service that are available to the user within the security context: the appliance service includes a user interface configured to interface with the user of the client device to: display the identified one or more repositories available to the user under the security context, and receive from the user a selection of one of the one or more repositories: and the appliance service is further configured to commit the document to the content management service by committing the document to the user selected repository.

### Example 38

The system of Example 33, wherein: the user interface is further configured to prompt the user for metadata for the document and receive user defined metadata; and the appliance service is further configured to commit the user defined metadata with the document to the content management service.

1. A method for storing documents in a content management service, the method comprising:
disposing an appliance service on a client device;
establishing a security context for a user of the client device, where the security context is established between the appliance service and the content management service;
presenting the appliance service as presenting the appliance service as a printer device option in an operating system device management user interface;
receiving a user print command to the appliance service indicating that a document is to be stored; and
responsive to receiving the user print command, sending a document storage command with a portable document format (PDF) version of the document from the appliance service to the content management service for storage in the security context for the user.

2. The method of claim 1, wherein the appliance service is preconfigured with the content management service for the security context for the user.

3. The method of claim 2, wherein the appliance service is predefined with meta-data and the document storage command includes the predefined meta-data.

4. The method of claim 1, where the method further includes:
presenting to the user one or more content management service options available to the user in the security context;
receiving a user selection of a selected one of the content management service options; and
where the step of sending a document storage command with a portable document format (PDF) version of the document from the appliance service to the content management service for storage in the security context for the user comprises sending a document storage command with a portable document format (PDF) version of the document from the appliance service to the selected one of the content management service options for storage in the security context for the user.

5. The method of claim 4, the method further including:
prompting the user for meta-data pertaining to the document;
receiving user defined meta-data pertaining to the document; and
where the step of sending a document storage command with the document from the appliance service to the content management service for storage in the security context for the user comprises sending a document storage command with the document and the user defined meta-data from the appliance service to the selected one of the content management service options for storage for storage of the document and the user defined meta-data.

6. The method of claim 4, the method further including querying the content management service to obtain the one or more content management service options available to the user in the security context.

7. The method of claim 1, the method further including:
prompting the user for user credentials;
receiving the user credentials; and
responsive to receiving the user credentials, authenticating the user credentials with an authentication service.

8. The method of claim 1, the method further including:
obtaining the user's single sign on (SSO) credentials; and
authenticating the user's SSO credentials with an authentication service.

9-10. (canceled)

11. The method of claim 1, where the content management service includes one or more repositories, each repository being capable of saving documents.

12. The method of claim 1, the method further includes:
receiving the document storage command with the PDF version of the document in the content management service; and
responsive to receiving the document storage command and the PDF version of the document in the content management service, storing the PDF version of the document in a repository of the content management service available to the user under the security context for the user.

13-21. (canceled)

23. A client device, the client device comprising:
a processor;
a display;
a user input device; and
a memory in communication with the processor, the memory having computer-readable instructions stored thereupon that, when executed by the processor, cause the processor to operate to:
provide an appliance service that establishes a security context with a content management service for a user of the client device;
present the appliance service on the display as a printer device option in an operating system resource management user interface;
receive a user pint command from the user input device indicating that a document is to be stored; and
responsive to receiving the user print command, sending a document storage command with a portable document format (PDF) version of the document from the appliance service to the content management service for storage in the security context for the user.

24. The client device of claim 23, wherein the appliance service is preconfigured with the content management service for the security context for the user.

25. The client device of claim 24, wherein the appliance service is predefined with meta-data and the appliance service operates to automatically communicate the predefined meta-data to the content management service for storage with the document.

26. The client device of claim 23, where the memory further includes computer executable instructions stored thereon which, when executed by the one or more processors, cause the one or more processors to operate such that the appliance service functions to:
present to the user one or more content management service options available to the user in the security context;
receive a user selection of a selected one of the content management service options; and
wherein, responsive to receiving the user print command, automatically communicate the document to the selected one of the content management service options for storage in the security context for the user.

27. The client device of claim 26, where the memory further includes computer executable instructions stored thereon which, when executed by the one or more processors, cause the one or more processors to operate such that the appliance service functions to:
prompt the user for meta-data pertaining to the document;
receive user defined meta-data pertaining to the document; and
wherein, responsive to receiving the user print command, automatically communicate the user defined meta-data pertaining to the document to the selected one of the content management service options for storage for storage with the document.

28. The client device of claim 26, where the memory further includes computer executable instructions stored thereon which, when executed by the one or more processors, cause the one or more processors to operate such that the appliance service functions to query the content management service for the one or more content management service options available to the user in the security context.

29. The client device of claim 23, where the memory further includes computer executable instructions stored thereon which, when executed by the one or more processors, cause the one or more processors to operate such that the appliance service establishes the security context for the user by operating to:
prompt the user for user credentials;
receive the user credentials; and
responsive to receiving the user credentials, authenticate the user credentials with an authentication service.

30. The client device of claim 23, where the memory further includes computer executable instructions stored thereon which, when executed by the one or more processors, cause the one or more processors to operate such that the appliance service establishes the security context for the user by operating to:
obtain the user's single sign on (SSO) credentials; and
authenticate the user's SSO credentials with an authentication service.

31-32. (canceled)

33. A system for managing documents in a security context, the system comprising:
a client device that includes:
an operating system having a resource management user interface that provides user access to resources residing on the client device including at least one of a file and a device; and
an appliance service that appears as an available printer driver option in the resource management user interface, where the appliance service is configured to:
authenticate a user of the client device with an authentication service, where, once the user is authenticated for a security context, the appliance service identifies a content management service available to the user within the security context,
receive from the user a print command that identifies a document, and
commit the document to the content management service.

34. The system of claim 33, wherein the appliance service is further configured perform at least one of:
authenticate the user of the client device by prompting the user for user credentials, receiving the user credentials, and communicating the user credentials to the authentication service; and
authenticate the user of the client device by obtaining single sign-on (SSO) credentials for the user and communicating the SSO credentials to the authentication service.

35-38. (canceled)
